(19) United States
(12) Patent Application Publication
(10) Pub. No.: US 2007/0003070 A1
(43) Pub. Date: Jan. 4, 2007

(54) Signal detection method and device

(75) Inventor: Hiroyuki Hayashita, Kobe-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/288,418

(22) Filed: Nov. 29, 2005

(30) Foreign Application Priority Data
Nov. 30, 2004 (JP) 2004-345390

(51) Int. Cl. H04R 29/00; H04N 7/00

(52) U.S. Cl. 381/56; 348/485

(57) ABSTRACT

A signal detection device is composed of a SAP detecting circuit that outputs a voltage corresponding to the level of a SAP signal; a noise detecting circuit that outputs a voltage corresponding to the level of a noise component; a SAP signal detection comparator that is capable of changing, if the level of a SIF signal is reduced, a reference bias according to that level and that determines whether there is a SAP signal based on the reference bias; a noise detection comparator that determines whether there is a noise component; and a SAP detection signal generating circuit that uniformly outputs, if the noise detection comparator determines that there is noise, a signal indicating that there is no SAP signal.

### BACKGROUND OF THE INVENTION

1. Field of the Invention

The present invention relates to a signal detection method and a signal detection device for use in a sound multiplex demodulator that supports US television broadcasts. The signal detection device is an device for detecting whether there is a Second Audio Program (hereinafter referred to as a SAP) signal in a US television broadcast. In particular, the signal detection device can achieve an improvement in field-strength sensitivity upon detection of a SAP signal and prevention of malfunction, when the electric field is weak.

2. Description of the Background Art

A US television sound multiplex broadcast provides two types of broadcasts, a stereo broadcast and a bilingual broadcast. A sound signal in the US television sound multiplex broadcast represents a composite signal which is a SIF (Sound Intermediate Frequency) demodulated output. In the composite signal, upon a stereo broadcast, an L−R signal is multiplexed in a frequency band higher than that of a conventional monophonic signal (or an L+R signal). In this case, the L−R signal is multiplexed as a suppressed carrier AM modulated signal with a center frequency of 2 fH (=31.5 KHz). Note that fH means the frequency (=15.75 KHz) of a horizontal synchronization signal. Upon a bilingual broadcast, a SAP signal is multiplexed, as a second audio, in an even higher frequency band. In this case, the SAP signal is multiplexed as an FM modulated signal with a center frequency of 5 fH.

FIG. 2 is a diagram showing a spectrum of a sound signal in the aforementioned US television sound multiplex broadcast, i.e., a composite signal which is a SIF demodulated output. In FIG. 2, a spectrum of an L+R signal, an AM modulated L−R signal, and an FM modulated SAP signal is shown. In FIG. 2, the vertical axis represents the sound carrier frequency deviation but not the signal level for the following reason. That is, on the sender of a broadcast, the signal level after SIF demodulation itself is not defined but the frequency deviation being ±25 KHz (preemphasis: OFF) at 100% modulation of L+R (mono) is defined.

A method of detecting a SAP signal upon the aforementioned bilingual broadcast will be explained below.

In a sound multiplex demodulation operation of a US television sound multiplex broadcast, a SAP signal is determined as follows. That is, the determination is made by detecting the level of a SAP signal contained in a composite signal and outputting a SAP detection signal which is a result of the detection.

FIG. 10 is a block diagram of a conventional art signal detection device that generates the SAP detection signal.

As shown in FIG. 10, the conventional art signal detection device is composed of an input terminal 1, a SIF demodulator circuit 2, a SAP signal detecting circuit 3, a SAP signal detection comparator 4, a reference bias circuit 5-1, a noise detecting circuit 6, a noise detection comparator 7, a reference bias circuit 8, a SAP detection signal generating circuit 9, and an output terminal 10.

A SIF signal is inputted to the input terminal 1.

The SIF demodulator circuit 2 demodulates the SIF signal inputted from the input terminal 1.

The SAP signal detecting circuit 3 is composed of a band-pass filter (hereinafter referred to as a BPF) 11 and a level detecting circuit 12. By this configuration, the SAP signal detecting circuit 3 detects the level of a SAP signal contained in a composite signal demodulated by the SIF demodulator circuit 2. Specifically, a DC voltage corresponding to the level of the SAP signal is outputted.

The SAP signal detection comparator 4 compares the level of the SAP signal detected by the SAP signal detecting circuit 3 with a reference bias for SAP signal detection provided by the reference bias circuit 5-1, and outputs a result of the comparison. The reference bias for SAP signal detection is preset to a predetermined value.

The noise detecting circuit 6 is composed of a BPF 13 and a level detecting circuit 14. By this configuration, the noise detecting circuit 6 detects the level of a noise component contained in the composite signal demodulated by the SIF demodulator circuit 2. Specifically, a DC voltage corresponding to the level of the noise component is outputted.

The noise detection comparator 7 compares the level of the noise component detected by the noise detecting circuit 6 with a reference bias for noise detection provided by the reference bias circuit 8, and outputs a result of the comparison. The reference bias for noise detection is preset to a predetermined value.

The SAP detection signal generating circuit 9 is composed of a logic circuit. The SAP detection signal generating circuit 9 accepts as input the comparison results from the SAP signal detection comparator 4 and the noise detection comparator 7 and generates a SAP detection signal.

The SAP detection signal generated by the SAP detection signal generating circuit 9 is outputted from the output terminal 10.

In the conventional art signal detection device shown in FIG. 10, when a SIF signal is inputted to the input terminal 1, the SIF signal is FM demodulated by the SIF demodulator circuit 2, whereby a composite signal is generated.

FIG. 3 is a diagram showing a relationship between the input level of the SIF demodulator circuit 2 and the SAP signal (5 fH) level and the output noise level. In FIG. 3, the horizontal axis takes the SIF input level and the vertical axis takes the output level of the SIF demodulator circuit 2. In the drawing, a curve A1 represents the case where there is a SAP signal (carrier: 100%). A curve A2 represents the case where there is no SAP signal (carrier: 0%).

For the SIF demodulator circuit, an FM demodulator circuit of a PLL system is employed. Therefore, by reducing the SIF input level to bring about a state where the electric field is weak, the noise level of an FM demodulated signal increases.

The aforementioned composite signal is inputted to each of the SAP signal detecting circuit 3 and the noise detecting circuit 6, which are connected to the SIF demodulator circuit 2. First, in the SAP signal detecting circuit 3, a component of a SAP signal band is extracted from the composite signal by the BPF 11 with a center frequency of 5 fH. The extracted component of a SAP signal band is subjected to full-wave rectification in the level detecting circuit 12 and thereby is converted into a DC voltage.

In the noise detecting circuit 6, a noise component is extracted from the composite signal by the BPF 13 with a center frequency near 10 fH. The extracted noise component is subjected to full-wave rectification in the level detecting circuit 14 and thereby is converted into a DC voltage.

The SAP signal detecting circuit 3 is set such that the higher the level of the SAP signal level the higher the output DC voltage thereof. Likewise, the noise detecting circuit 6 is set such that the higher the level of the noise component the higher the output DC voltage thereof.

FIG. 4 is a diagram showing the frequency characteristics of the BPF 11 with a center frequency near 5 fH. FIG. 5 is a diagram showing the frequency characteristics of the BPF 13 with a center frequency near 10 fH.

FIG. 6 is a diagram showing a relationship between the SIF input level and the output level of the BPF 11. In FIG. 6, the horizontal axis takes the SIF input level and the vertical axis takes the output level of the BPF 11. In the drawing, a curve B1 represents the case where there is a SAP signal (carrier: 100%). A curve B2 represents the case where there is no SAP signal (carrier: 0%).

FIG. 7 is a diagram showing a relationship between the SIF input level and the output level of the BPF 13. The horizontal axis takes the SIF input level and the vertical axis takes the output level of the BPF 13. In the drawing, a curve C1 represents the case where there is a SAP signal (carrier: 100%). A curve C2 represents the case where there is no SAP signal (carrier: 0%).

The SAP signal detection comparator 4 compares an output DC voltage from the SAP signal detecting circuit 3 with a reference bias for SAP signal detection from the reference bias circuit 5-1. By this, if the output DC voltage from the SAP signal detecting circuit 3 is higher than or equal to the reference bias for SAP signal detection, the SAP signal detection comparator 4 outputs a high level; otherwise, the SAP signal detection comparator 4 outputs a low level.

In the conventional art signal detection device, the SAP signal detection level is set to about 20% of the broadcast standard value. About 20% of the broadcast standard value is equivalent to ±15 KHz*0.2 in the SIF modulation level. The aforementioned reference bias for SAP signal detection is set to a voltage corresponding to ±15 KHz*0.2 in the SIF modulation level.

There is a possibility that in a weak electric field region where the television radio wave is weak, even when there is no SAP signal, due to the noise that is increased near 5 fH, it may be mistakenly determined that there is a SAP signal. In order to prevent such a misdetermination, the noise detecting circuit 6, the noise detection comparator 7, the reference bias circuit 8, and the SAP detection signal generating circuit 9 are provided.

The noise detecting circuit 6 detects a noise of a band near 10 fH where the phenomenon of increase in noise appears in a weak electric field region, as in the SAP signal band.

The noise detection comparator 7 compares an output DC voltage from the noise detecting circuit 6 with a reference bias for noise detection from the reference bias circuit 8. By this, if the output DC voltage from the noise detecting circuit 6 is higher than or equal to the reference bias for noise detection, the noise detection comparator 7 outputs a high level; otherwise, the noise detection comparator 7 outputs a low level.

The SAP detection signal generating circuit 9 outputs an AND of an output from the SAP signal detection comparator 4 and an inverted logic of an output from the noise detection comparator 7. Thus, if the output from the noise detection comparator 7 is a high level, regardless of the output value of the SAP signal detection comparator 4, i.e., regardless of whether there is a SAP signal input, the SAP detection signal generating circuit 9 determines that “there is no SAP signal”.

FIG. 11A is a diagram showing a relationship between the input level of a SIF signal to be inputted to the input terminal 1 of FIG. 10 and the input voltage (+ side input) of the comparator 4. The horizontal axis takes the SIF input level and the vertical axis takes the input voltage (+ side input) of the SAP signal detection comparator 4. In the drawing, a curve D1 represents the case where there is a SAP signal (carrier: 100%). A curve D2 represents the case where there is no SAP signal (carrier: 0%). In addition, in FIG. 11A, a reference bias Vsth1 (− side input) in the SAP signal detection comparator 4 is represented by a dashed line.

FIG. 11B is a diagram showing a relationship between the input level of a SIF signal and the input voltage (+ side input) of the noise detection comparator 7. The horizontal axis takes the SIF input level and the vertical axis takes the input voltage (+ side input) of the noise detection comparator 4. In the drawing, a curve E1 represents the case where there is a SAP signal (carrier: 100%). A curve E2 represents the case where there is no SAP signal (carrier: 0%). In addition, in FIG. 11B, a reference bias Vnth1 (− side input) in the noise detection comparator 7 is represented by a dashed line.

First, as shown in FIG. 11A, the SAP signal detecting circuit 3 is set such that, when a SAP signal is inputted, in a strong electric field (greater than or equal to 60 dBμV) the higher the SAP carrier level the higher the output DC voltage of the SAP signal detecting circuit 3. The reference bias for SAP signal detection in the SAP signal detection comparator 4 is set to a voltage Vsth1 (2.85 V) so that when the SAP signal has a level higher than or equal to about 20% of the broadcast standard value, it is determined that there is a SAP signal.

When a SAP signal is not inputted, by reducing the SIF signal input level to bring about a weak electric field, the noise of a band near 5 fH in FIG. 2 increases. As a result, the output DC voltage of the SAP signal detecting circuit 3 increases and in a weak electric field lower than or equal to 46 dBμV where the output DC voltage is higher than the voltage Vsth1 misdetection of a SAP signal is caused. As a result, the SAP signal detection comparator 4 outputs a high level.

On the other hand, as shown in FIG. 11B, the output DC voltage of the noise detecting circuit 6 increases as the electric field gets weak. The reference bias for noise detection in the noise detection comparator 7 is set to a voltage Vnth1 (2.92 V). Therefore, the noise detection comparator 7 outputs a high level in a weak electric field lower than or equal to 48 dBμV.

As described above, the SAP detection signal generating circuit 9 allows the AND of an output from the SAP signal detection comparator 4 and the inversion of an output from the noise detection comparator 7 to serve as a SAP detection output signal. That is, a noise component is detected before a SAP signal is mistakenly detected due to noise in a weak electric field region. By this, SAP signal detection is forcefully canceled by the SAP detection signal generating circuit 9, whereby misdetection of a SAP signal is prevented.

For conventional art documents related to this, patent document 1 is known, for example.

Patent document 1: Patent No. 2710461

In the SAP signal detection scheme by conventional art, however, there is the following problem. Specifically, in a weak electric field region where the television radio wave is weak, despite the fact that a SAP signal is actually multiplexed, it is forcefully determined by a result of a determination made by the noise detecting circuit 6 that “there is no SAP”. This results in keeping only up to 48 dBμV for the field-strength sensitivity upon detection of a SAP signal.

### SUMMARY OF THE INVENTION

An object of the present invention is to provide a signal detection method and a signal detection device, by which the problem in the aforementioned conventional art is solved, and which are capable of reducing the possibility of misdetection of a SAP signal caused by noise when the electric field is weak.

Another object of the present invention is to provide a signal detection method and a signal detection device which are capable of improving the field-strength sensitivity upon detection of a SAP signal without a SAP signal being mistakenly detected due to noise when the electric field is weak.

To solve the foregoing problem, a signal detection method of the present invention comprises:

a first step of detecting a level of a SIF signal and changing a reference bias for SAP signal detection according to a reduction in the level of the SIF signal; and

a second step of detecting a level of a SAP signal contained in a composite signal that is demodulated from the SIF signal and comparing the level of the SAP signal with the reference bias for SAP signal detection that is changed in the first step, thereby determining whether there is the SAP signal.

According to the method, the level (field strength) of a SIF signal is detected and the reference bias for SAP signal detection is increased to reduce the SAP signal detection sensitivity. By this, the possibility of misdetection of a SAP signal caused by noise when the electric field is weak can be reduced.

The aforementioned signal detection method of the present invention may further comprise:

a third step of detecting a level of a noise component contained in the composite signal and comparing the level of the noise component with a preset reference bias for noise detection, thereby determining whether there is the noise component; and

a fourth step of determining, if it is determined in the third step that there is the noise component, that there is no SAP signal, regardless of a result of the determination made in the second step as to whether there is the SAP signal.

According to the method, the level (field strength) of a SIF signal is detected and the reference bias for SAP signal detection is increased when the electric field is weak to reduce the SAP signal detection sensitivity. By this, the possibility of misdetection of a SAP signal caused by noise can be reduced. Hence, by increasing the reference bias for noise detection, the noise detection sensitivity can be reduced. As a result, the field-strength sensitivity for SAP signal detection can be improved without a SAP signal being mistakenly detected when the electric field is weak.

A signal detection device of the present invention comprises:

a SAP signal detecting means that detects a level of a SAP signal contained in a composite signal that is demodulated from a SIF signal and outputs a voltage corresponding to the level of the SAP signal;

a first reference bias generating means that generates a variable reference bias for SAP signal detection;

a SAP signal detection comparing means that compares the output voltage of the SAP signal detecting means with the reference bias for SAP signal detection, thereby determining whether there is the SAP signal; and

a SIF signal level detecting means that detects a level of the SIF signal and changes, according to the level of the SIF signal, the reference bias for SAP signal detection generated by the first reference bias generating means, wherein
the reference bias for SAP signal detection generated by the first reference bias generating means is changed, according to a reduction in the level of the SIF signal, in a direction in which a SAP signal detection sensitivity by the SAP signal detecting means is reduced.

According to this configuration, the level (field strength) of a SIF signal is detected and the reference bias for SAP signal detection is increased when the electric field is weak to reduce the SAP signal detection sensitivity. By this, the possibility of misdetection of a SAP signal caused by noise can be reduced.

The aforementioned signal detection device of the present invention may further comprise:

a noise detecting means that detects a level of a noise component contained in the composite signal and outputs a voltage corresponding to the level of the noise component;

a second reference bias generating means that generates a reference bias for noise detection;

a noise detection comparing means that compares the output voltage of the noise detecting means with the reference bias for noise detection, thereby determining whether there is the noise component; and

a SAP detection signal generating means that outputs, if the noise detection comparing means determines that there is no noise component, a signal indicating that there is the SAP signal or that there is no SAP signal according to a result of the determination made by the SAP signal detection comparing means, and outputs, if the noise detection comparing means determines that there is the noise component, a signal indicating that there is no SAP signal, regardless of the result of the determination made by the SAP signal detection comparing means.

According to this configuration, the level (field strength) of a SIF signal is detected by the SIF signal level detecting means and the reference bias in the SAP signal detection comparator is increased when the electric field is weak to reduce the SAP signal detection sensitivity. By this, the possibility of misdetection of a SAP signal caused by noise can be reduced. Hence, by increasing the reference bias in the noise detection comparator, the noise detection sensitivity can be reduced. As a result, the field-strength sensitivity for SAP signal detection can be improved without a SAP signal being mistakenly detected when the electric field is weak.

The SAP signal detecting circuit detects the level of a SAP signal and outputs a voltage corresponding to that level. Here, the voltage corresponding to the level of the SAP signal may be set, for example, such that the voltage increases as the level of the SAP signal increases. Then, by comparing the output voltage of the SAP signal detecting circuit with the reference bias for SAP signal detection in the SAP signal detection comparator, whether there is a SAP signal is determined. The same as the above applies to the noise detecting circuit and the noise detection comparator. The SIF signal level detecting circuit detects, when the level of the SIF signal is reduced (when the electric field is weak), the reduction and changes the reference bias in the SAP signal detecting circuit. By this, even if the output voltage of the SAP signal detecting circuit fluctuates when the electric field is weak, the reference bias can be set according to the fluctuation. Therefore, the reference bias in the noise detecting circuit can be further increased.

A circuit configuration of a SAP detection signal generating circuit is as follows. Specifically, if the noise detection comparator determines that there is noise, regardless of a result of a determination made by the SAP signal detection comparator, it is determined that there is no SAP signal. For example, for the case where when the SAP signal detection comparator determines that there is a SAP signal a “high level” is outputted, and when the noise detection comparator determines that there is noise a “high level” is outputted, the following circuit configuration may be employed. Specifically, an output from the SAP signal detection comparator and the inverted logic of an output from the noise detection comparator become AND.

In the aforementioned signal detection device of the present invention, the SIF signal level detecting means includes: for example,

a SIF signal detecting means that detects the level of the SIF signal and generates a voltage corresponding to the level of the SIF signal;

a third reference bias generating means that generates a reference bias for SIF signal detection; and

a SIF signal detection comparing means that compares the output voltage of the SIF signal detecting means with the reference bias for SIF signal detection, thereby determining whether the SIF signal is strong or weak, and changes, according to a result of the determination as to whether the SIF signal is strong or weak, the reference bias for SAP signal detection generated by the first reference bias generating means.

In the signal detection device of the present invention, it is preferred that each of the SAP signal detection comparing means, the noise detection comparing means, and the SIF signal detection comparing means have a hysteresis characteristic.

According to this configuration, the chattering of each comparing means can be suppressed and thus the comparison operation can be stabilized.

As explained above, according to the present invention, the level (field strength) of a SIF signal is detected and a reference bias for SAP signal detection is increased when the electric field is weak to reduce the SAP signal detection sensitivity. By this, the possibility of misdetection of a SAP signal caused by noise can be reduced.

When the field strength of a SIF signal is reduced, the reference bias for SAP signal detection used to determine whether there is a SAP signal is changed to reduce the SAP signal detection sensitivity. This makes it possible to reduce the noise detection sensitivity. As a result, the field-strength sensitivity upon detection of a SAP signal can be improved while preventing misdetection of a SAP signal.

### BRIEF DESCRIPTION OF THE DRAWINGS

FIG. 1 is a block diagram showing a configuration of a signal detection device according to an embodiment of the present invention.

FIG. 2 is a diagram showing a spectrum of a sound signal in a US television sound multiplex broadcast.

FIG. 3 is a characteristic diagram showing input-output characteristics regarding a SAP signal and noise of a SIF demodulator circuit 2 in each of the embodiment of the present invention and conventional art.

FIG. 4 is a characteristic diagram showing frequency characteristics of a BPF 11 for SAP signal detection in each of the embodiment of the present invention and the conventional art.

FIG. 5 is a characteristic diagram showing frequency characteristics of a BPF 13 for noise detection in each of the embodiment of the present invention and the conventional art.

FIG. 6 is diagram showing a relationship between a SIF input level and an output level of the BPF 11 in each of the embodiment of the present invention and the conventional art.

FIG. 7 is diagram showing a relationship between the SIF input level and an output level of the BPF 13 in each of the embodiment of the present invention and the conventional art.

FIG. 8A is a diagram showing a relationship between the SIF input level and an input voltage of a SIF signal detection comparator 16 in the embodiment of the present invention.

FIG. 8B is a diagram showing a relationship between the SIF input level and an output voltage of the SIF signal detection comparator 16 in the embodiment of the present invention.

FIG. 8C is a diagram showing a relationship between the SIF input level and a voltage at an inverting input terminal of a SAP signal detection comparator 4 in the embodiment of the present invention.

FIG. 9A is a diagram showing a relationship between an input level of a SIF signal to be inputted to an input terminal 1 of FIG. 1 and an input voltage of the SAP signal detection comparator 4 in the embodiment of the present invention.

FIG. 9B is a diagram showing a relationship between the input level of the SIF signal and an input voltage of a noise detection comparator 7 in the embodiment of the present invention.

FIG. 10 is a block diagram showing a configuration of a conventional art signal detection device.

FIG. 11A is a diagram showing a relationship between an input level of a SIF signal to be inputted to an input terminal 1 of FIG. 10 and an input voltage of a SAP signal detection comparator 4 in the conventional art signal detection device.

FIG. 11B is a diagram showing a relationship between the input level of the SIF signal and an input voltage of a noise detection comparator 7 in the conventional art signal detection device.

### DESCRIPTION OF THE PREFERRED EMBODIMENTS

Embodiments of the present invention will be explained below with reference to the drawings.

### Embodiment

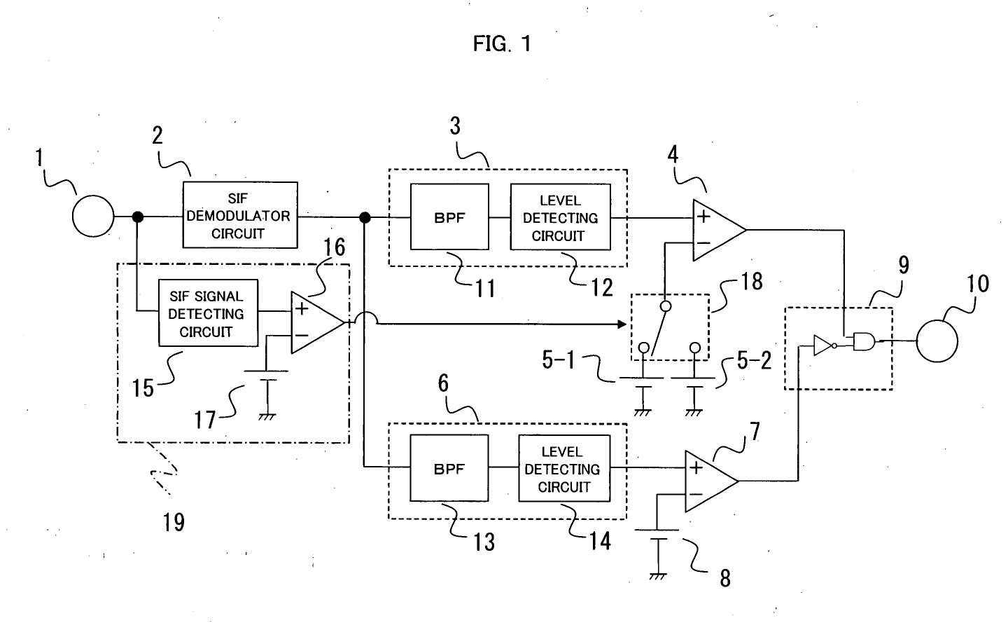

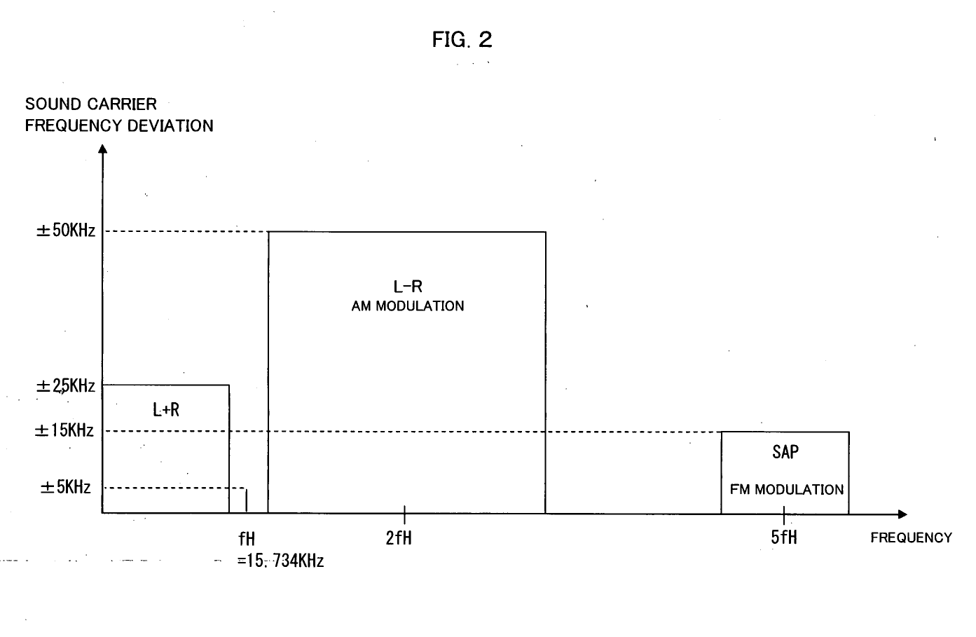

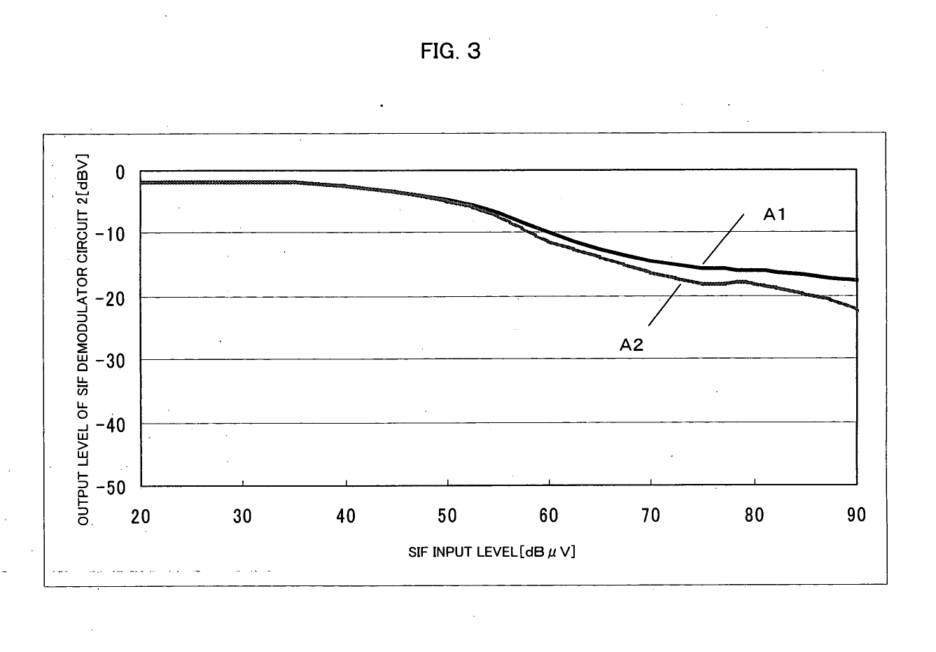

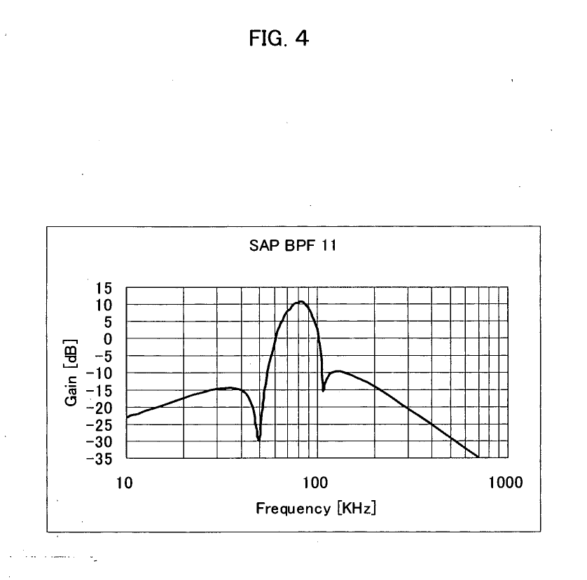

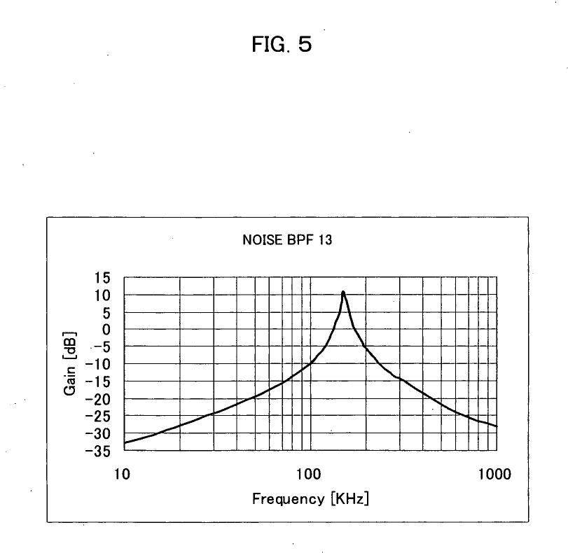

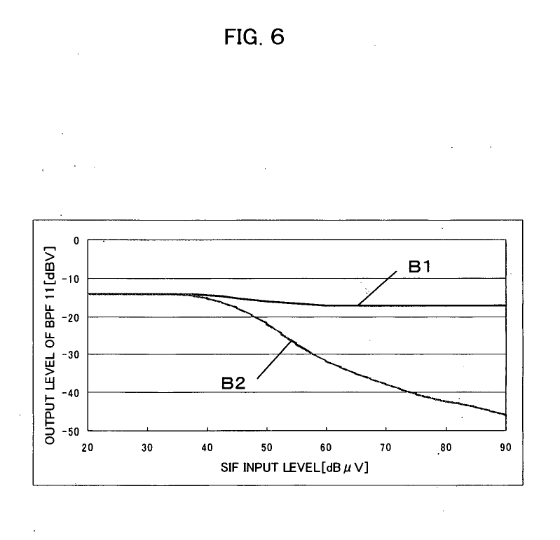

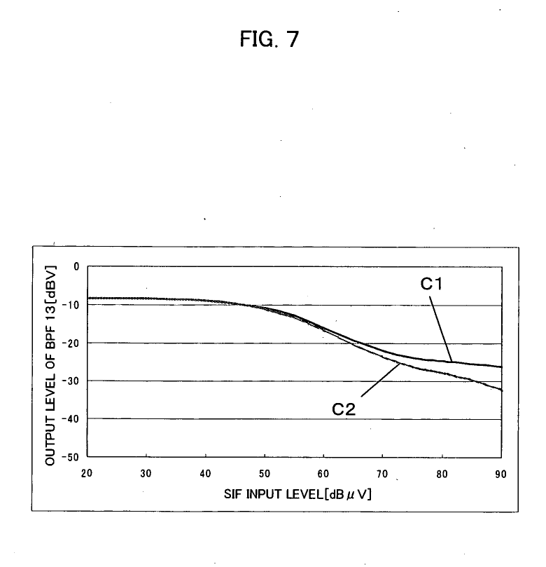

FIG. 1 is a block diagram showing a configuration of a signal detection device according to an embodiment of the present invention. As shown in FIG. 1, the signal detection device according to the embodiment of the present invention is composed of an input terminal 1, a SIF demodulator circuit 2, a SAP signal detecting circuit 3, a SAP signal detection comparator 4, reference bias circuits 5-1 and 5-2 which serve as a first reference bias generating means, a switch 18, a noise detecting circuit 6, a noise detection comparator 7, a reference bias circuit 8 which serves as a second reference bias generating means, a SAP detection signal generating circuit 9, an output terminal 10, a SIF signal detecting circuit 15, a SIF level detection comparator 16, and a reference bias circuit 17 which serves as a third reference bias generating means.

A SIF signal is inputted to the input terminal 1.

A SIF signal level detecting circuit 19 is composed of the SIF signal detecting circuit 15, the SIF level detection comparator 16, and the reference bias circuit 17. The SIF signal level detecting circuit 19 detects the level of the SIF signal and changes a reference bias for SAP signal detection according to the level of the SIF signal.

The SIF demodulator circuit 2 demodulates the SIF signal inputted from the input terminal 1.

The SAP signal detecting circuit 3 is composed of a BPF 11 with a center frequency of 5 fH and a level detecting circuit 12. The level detecting circuit 12 performs full-wave rectification on a component of a SAP signal band that is extracted by the BPF 11 and converts the component into a DC voltage. By this configuration, the SAP signal detecting circuit 3 detects the level of a SAP signal contained in a composite signal that is demodulated by the SIF demodulator circuit 2.

The SAP signal detection comparator 4 compares the level of the SAP signal detected by the SAP signal detecting circuit 3 with a reference bias for SAP detection provided by either one of the reference bias circuits 5-1 and 5-2. The SAP signal detection comparator 4 then outputs a result of the comparison. The aforementioned reference bias for SAP signal detection is preset to a predetermined value.

The switch 18 selects either one of reference biases for SAP signal detection in the reference bias circuits 5-1 and 5-2 and inputs the selected reference bias to the SAP signal detection comparator 4.

The noise detecting circuit 6 is composed of a BPF 13 with a center frequency of 10 fH and a level detecting circuit 14. The level detecting circuit 14 performs full-wave rectification on a component of a noise band that is extracted by the BPF 13 and converts the component into a DC voltage. By this configuration, the noise detecting circuit 6 detects the level of a noise component contained in the composite signal that is demodulated by the SIF demodulator circuit 2.

The noise detection comparator 7 compares the level of the noise component detected by the noise detecting circuit 6 with a reference bias for noise detection provided by the reference bias circuit 8. The noise detection comparator 7 then outputs a result of the comparison. The reference bias for noise detection is preset to a predetermined value.

The SAP detection signal generating circuit 9 is composed of a logic circuit. The SAP detection signal generating circuit 9 accepts as input the comparison results from the SAP signal detection comparator 4 and the noise detection comparator 7 and generates a SAP detection signal.

The SAP detection signal generated by the SAP detection signal generating circuit 9 is outputted from the output terminal 10.

The SIF signal detecting circuit 15 detects the level of the SIF signal inputted from the input terminal 1.

The SIF signal detection comparator 16 compares the level of the SIF signal detected by the SIF signal detecting circuit 15 with a reference bias for SIF signal detection provided by the reference bias circuit 17. The SIF signal detection comparator 16 then outputs a result of the comparison. The reference bias for SIF signal detection is preset to a predetermined value.

The aforementioned switch 18 is controlled to be switched according to the comparison result outputted from the SIF signal detection comparator 16. Specifically, the output from the SIF signal detection comparator 16 changes in response to the level of a SIF signal detected by the SIF signal detecting circuit 15. Then, the switch 18 is controlled according to the output from the SIF signal detection comparator 16, whereby the reference bias in the aforementioned SAP signal detection comparator 4 can be changed.

Next, with reference to FIG. 1, the operation of detecting a SAP signal in the signal detection device according to the present embodiment will be explained.

In FIG. 1, when a SIF signal is inputted to the input terminal 1, the SIF signal is provided to each of the SIF demodulator circuit 2 and the SIF signal detecting circuit 15. The SIF demodulator circuit 2 demodulates the SIF signal and generates a composite signal. The composite signal is inputted to each of the SAP signal detecting circuit 3 and the noise detecting circuit 6.

In the SAP signal detecting circuit 3, a component of a SAP signal band is extracted from the composite signal by the BPF 11 with a center frequency of 5 fH. The extracted component of a SAP signal band is subjected to full-wave rectification in the level detecting circuit 12, and thereby is converted into a DC voltage.

On the other hand, in the noise detecting circuit 6, a noise component is extracted from the composite signal by the BPF 13 with a center frequency near 10 fH. The extracted noise component is subjected to full-wave rectification in the level detecting circuit 14, and thereby is converted into a DC voltage.

The SAP signal detecting circuit 3 then outputs the output DC voltage to the SAP signal detection comparator 4. Likewise, the noise detecting circuit 6 outputs the output DC voltage to the noise detection comparator 7.

As in the conventional art, in the present embodiment too, it is set such that the higher the SAP signal level or the noise level the higher the output DC voltage of the SAP signal detecting circuit 3 or the noise detecting circuit 6.

The SAP signal detection comparator 4 compares the output DC voltage from the SAP signal detecting circuit 3 with the reference bias for SAP signal detection from either one of the reference bias circuits 5-1 and 5-2. As a result of the comparison, if the output DC voltage is higher than or equal to the reference bias, a high level is outputted, and if the output DC voltage is lower than the reference bias, a low level is outputted.

Note, however, that in the present embodiment the SIF signal is AM detected (peak-held) by the SIF signal detecting circuit 15, whereby a DC voltage proportional to the level of the SIF signal is outputted. The DC voltage and a reference voltage for SIF signal detection from the reference bias circuit 17 are compared in the SIF signal detection comparator 16. A result of the comparison made by the SIF signal detection comparator 16 serves as a control signal for the switch 18.

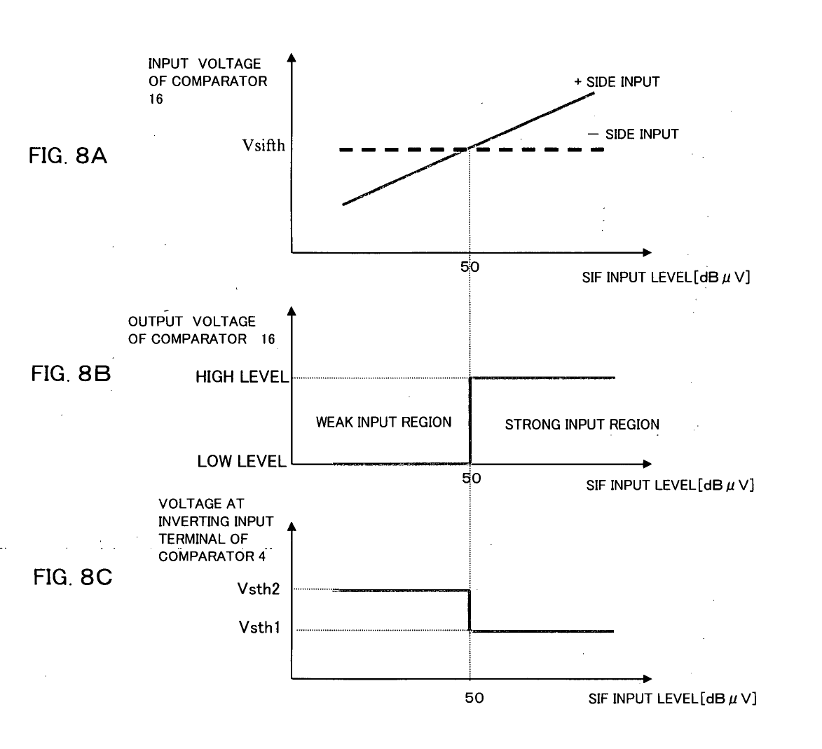

FIG. 8A is a diagram showing a relationship between the SIF input level and the input voltage of the SIF signal detection comparator 16. FIG. 8B is a diagram showing a relationship between the SIF input level and the output voltage of the SIF signal detection comparator 16. FIG. 8C is a diagram showing a relationship between the SIF input level and the voltage at an inverting input terminal of the SAP signal detection comparator 4.

In the embodiment of the present invention, it is set such that the SIF input level being in a region higher than or equal to 50 dBμV is determined to be in a strong electric field and thus the output from the SIF signal detection comparator 16 is a high level. Specifically, the reference bias for SIF signal detection by the reference bias circuit 17 is set to a voltage Vsifth. If it is determined to be in a strong electric field, the switch 18 is controlled to be connected to the reference bias circuit 5-1.

Conversely, the SIF input level being in a region lower than 50 dBμV is determined to be in a weak electric field and thus the output from the comparator 16 is a low level. As a result, the switch 18 is controlled to be connected to the reference bias circuit 5-2.

Here, the reference bias for SAP signal detection of the reference bias circuit 5-1 is set to about 20% of the broadcast standard value, as in the conventional art. The reference bias for SAP signal detection of the reference bias circuit 5-2 is set to about 40% of the broadcast standard value. That is, the reference bias in the comparator 4 is set according to the case where the input level of the SIF signal is in the strong or weak electric field. Therefore, the reference bias for noise detection that is provided to the noise detection comparator 7 can be further increased over the conventional art. By this, the noise detection sensitivity can be reduced. As a result, an improvement in field-strength sensitivity upon detection of a SAP signal can be achieved.

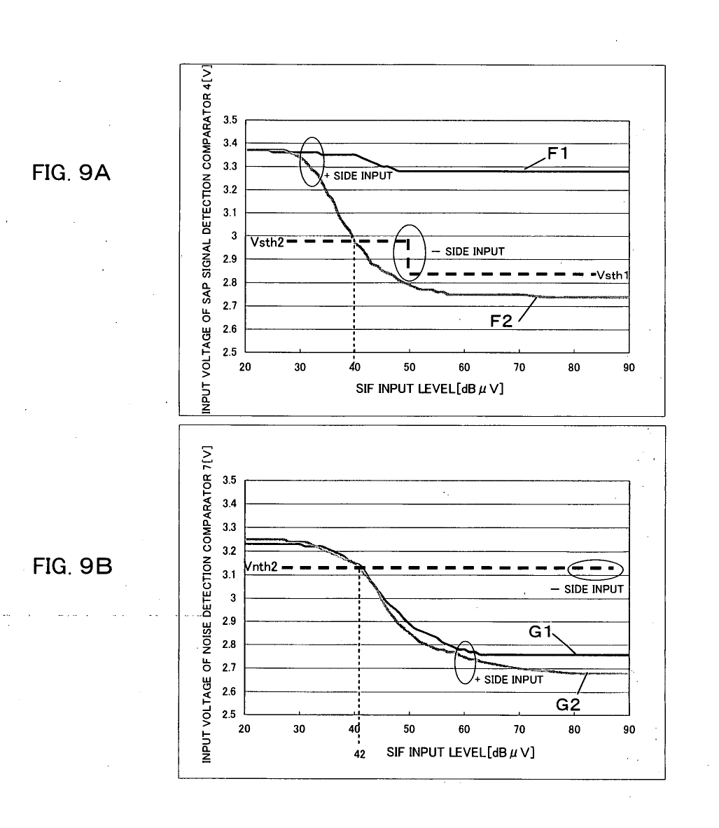

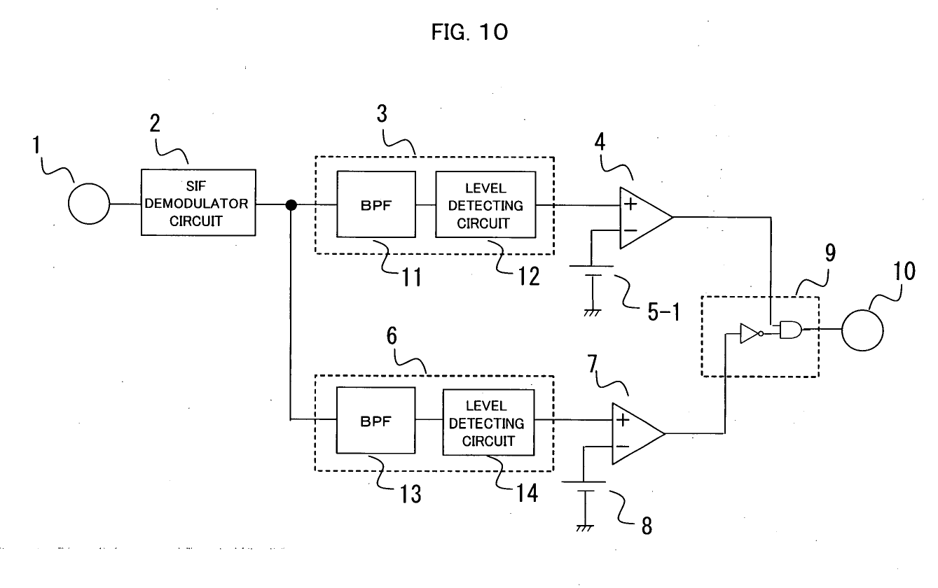

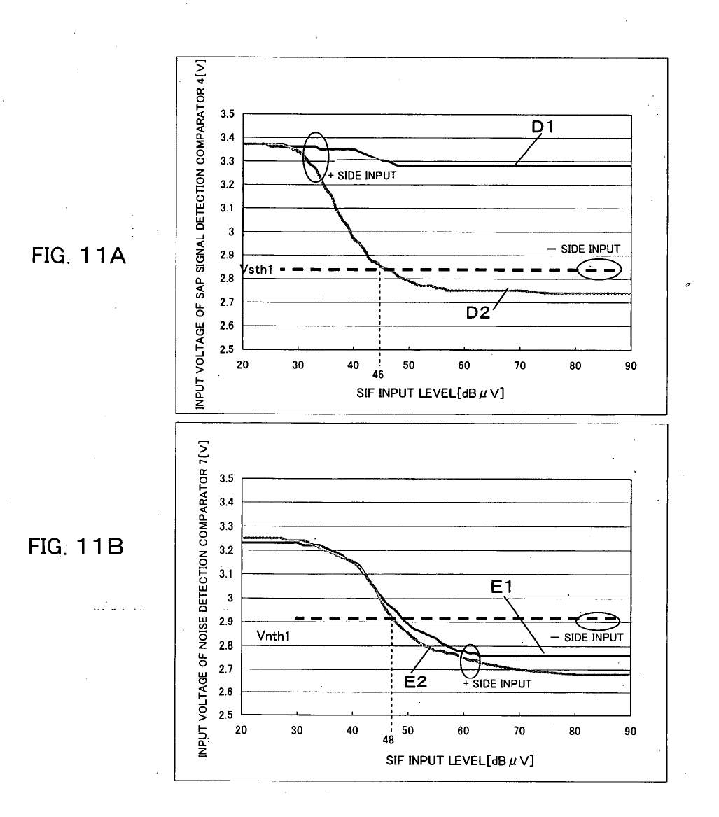

FIG. 9A is a diagram showing a relationship between the input level of a SIF signal to be inputted to the input terminal 1 of FIG. 1 and the input voltage of the SAP signal detection comparator 4. The horizontal axis takes the SIF input level and the vertical axis takes the input voltage (+ side input) of the SAP signal detection comparator 4. In the drawing, a curve F1 represents the case where there is a SAP signal (carrier: 100%). A curve F2 represents the case where there is no SAP signal (carrier: 0%). In addition, in FIG. 9A, reference biases for SAP signal detection Vsth1 and Vsth2 (− side inputs) to the SAP signal detection comparator 4 are represented by dashed lines.

FIG. 9B is a diagram showing a relationship between the input level of the SIF signal and the input voltage of the noise detection comparator 7. The horizontal axis takes the SIF input level and the vertical axis takes the input voltage (+ side input) of the noise detection comparator 7. In the drawing, a curve G1 represents the case where there is a SAP signal (carrier: 100%). A curve G2 represents the case where there is no SAP signal (carrier: 0%). In addition, in FIG. 9B, a reference bias for noise detection Vnth1 (− side input) to the noise detection comparator 7 is represented by a dashed line.

As described above, in FIG. 9A, two reference biases for SAP signal detection Vsth1 and Vsth2 are shown. In the present embodiment, when a weak electric field is brought about by reducing the SIF input level, the reference bias for SAP signal detection in the SAP signal detection comparator 4 is increased. Specifically, when the SIF input level is below 50 dBμV, the reference bias for SAP signal detection in the SAP signal detection comparator 4 is increased from Vsth1 (2.85V) to Vsth2 (2.98 V). Hence, the field strength at which, when no SAP signal is inputted, a SAP signal is mistakenly detected due to noise is about 40 dBμV. Accordingly, the reference bias for noise detection to the noise detection comparator 7 is set to Vnth2 (3.12 V) so that noise is detected at an electric field near the about 40 dBμV, e.g., 42 dBμV.

By employing the aforementioned detection scheme, the noise detection field strength can be reduced from 48 dBμV to 42 dBμV. As a result, the field-strength sensitivity upon detection of a SAP signal can be improved by 6 dB while preventing misdetection of a SAP signal.

According to this configuration, the level (field strength) of a SIF signal is detected by the SIF signal level detecting circuit, and when the electric field is weak, the reference bias in the SAP signal detection comparator 4 is increased to reduce the SAP signal detection sensitivity. By this, the possibility of misdetection of a SAP signal caused by noise can be reduced. Accordingly, by increasing the reference bias in the noise detection comparator 7, the noise detection sensitivity can be reduced. As a result, the field-strength sensitivity for SAP signal detection can be improved without a SAP signal being mistakenly detected when the electric field is weak.

By the signal detection device explained above, the following signal detection method is performed. The signal detection method, a signal detection method of the present invention, includes:

a first step of detecting the level of a SIF signal and changing, if the level of the SIF signal is reduced, a reference bias for SAP signal detection according to the level of the SIF signal;

a second step of detecting the level of a SAP signal contained in a composite signal that is demodulated from the SIF signal and comparing the level of the SAP signal with the reference bias for SAP signal detection that is changed in the first step, thereby determining whether there is a SAP signal;

a third step of detecting the level of a noise component contained in the composite signal and comparing the level of the noise component with a preset reference bias for noise detection, thereby determining whether there is a noise component; and

a fourth step of determining, if it is determined in the third step that there is a noise component, that there is no SAP signal, regardless of a result of the determination made in the second step as to whether there is a SAP signal.

According to the method, the level (field strength) of a SIF signal is detected, and when the electric field is weak, the reference bias for SAP signal detection is increased to reduce the SAP signal detection sensitivity. By this, the possibility of misdetection of a SAP signal caused by noise can be reduced. Accordingly, by increasing the reference bias for noise detection, the noise detection sensitivity can be reduced. As a result, the field-strength sensitivity for SAP signal detection can be improved without a SAP signal being mistakenly detected when the electric field is weak.

### Other Embodiments

Although in the aforementioned embodiment of the present invention the reference bias for SAP signal detection in the SAP signal detection comparator is switched between two values according to the level of a SIF signal, even if the reference bias is switched between three or more values, the same advantageous effect can be obtained. In that case, the SIF signal level needs to be divided into three or more ranges with two or more reference biases for SIF signal detection. It is also necessary to prepare three or more values for the reference bias for SAP signal detection.

Even if the reference bias for SAP signal detection is controlled linearly according to the SIF input level, the same advantageous effect can be obtained. In that case, the SIF signal level needs to be detected continuously but not stepwise. The reference bias for SAP signal detection also needs to be continuously changed according to the result of the detection of the SIF signal level.

By adding a hysteresis characteristic to the comparators 4, 7, and 16, the oscillation (chattering) of the signal detection operation in the output switching region of the comparators can be suppressed.

The noise detecting circuit 6, the noise detection comparator 7, the reference bias circuit 8, and the SAP detection signal generating circuit 9 may be omitted, depending on the usage environment.

### INDUSTRIAL APPLICABILITY

A signal detection method and a signal detection device of the present invention relate to a sound multiplex demodulator for US television broadcasts, and are effective, in particular, at improving field-strength sensitivity upon detection of a Second Audio Program (SAP) and preventing malfunction, when the electric field is weak.

What is claimed is:

1. A signal detection method comprising:
a first step of detecting a level of a SIF signal and changing a reference bias for SAP signal detection according to a reduction in the level of the SIF signal; and
a second step of detecting a level of a SAP signal contained in a composite signal that is demodulated from the SIF signal and comparing the level of the SAP signal with the reference bias for SAP signal detection that is changed in the first step, thereby determining whether there is the SAP signal.

2. The signal detection method according to claim 1, further comprising:
a third step of detecting a level of a noise component contained in the composite signal and comparing the level of the noise component with a preset reference bias for noise detection, thereby determining whether there is the noise component; and
a fourth step of determining, if it is determined in the third step that there is the noise component, that there is no SAP signal, regardless of a result of the determination made in the second step as to whether there is the SAP signal.

3. A signal detection device comprising:
a SAP signal detecting means that detects a level of a SAP signal contained in a composite signal that is demodulated from a SIF signal and outputs a voltage corresponding to the level of the SAP signal;
a first reference bias generating means that generates a variable reference bias for SAP signal detection;
a SAP signal detection comparing means that compares the output voltage of the SAP signal detecting means with the reference bias for SAP signal detection, thereby determining whether there is the SAP signal; and
a SIF signal level detecting means that detects a level of the SIF signal and changes, according to the level of the SIF signal, the reference bias for SAP signal detection generated by the first reference bias generating means, wherein
the reference bias for SAP signal detection generated by the first reference bias generating means is changed, according to a reduction in the level of the SIF signal, in a direction in which a SAP signal detection sensitivity by the SAP signal detecting means is reduced.

4. The signal detection device according to claim 3, further comprising:
a noise detecting means that detects a level of a noise component contained in the composite signal and outputs a voltage corresponding to the level of the noise component;
a second reference bias generating means that generates a reference bias for noise detection;
a noise detection comparing means that compares the output voltage of the noise detecting means with the reference bias for noise detection, thereby determining whether there is the noise component; and
a SAP detection signal generating means that outputs, if the noise detection comparing means determines that there is no noise component, a signal indicating that there is the SAP signal or that there is no SAP signal according to a result of the determination made by the SAP signal detection comparing means, and outputs, if the noise detection comparing means determines that there is the noise component, a signal indicating that there is no SAP signal, regardless of the result of the determination made by the SAP signal detection comparing means.

5. The signal detection device according to claim 3, wherein the SIF signal level detecting means includes:
a SIF signal detecting means that detects the level of the SIF signal and generates a voltage corresponding to the level of the SIF signal;
a third reference bias generating means that generates a reference bias for SIF signal detection; and
a SIF signal detection comparing means that compares the output voltage of the SIF signal detecting means with the reference bias for SIF signal detection, thereby determining whether the SIF signal is strong or weak, and changes, according to a result of the determination as to whether the SIF signal is strong or weak, the reference bias for SAP signal detection generated by the first reference bias generating means.

6. The signal detection device according to claim 5, wherein each of the SAP signal detection comparing means, the noise detection comparing means, and the SIF signal detection comparing means has a hysteresis characteristic.
